(19) United States
(12) Patent Application Publication
(10) Pub. No.: US 2003/0119543 A1
(43) Pub. Date: Jun. 26, 2003

(54) Portable communication device interchangeable user input module

(76) Inventors: Tony N. Kfoury, Lisle, IL (US); Michael D. Hareng, Lake In The Hills, IL (US)

Correspondence Address: MOTOROLA INC, 600 NORTH US HIGHWAY 45, LIBERTYVILLE, IL, 60048-5343, US

(21) Appl. No.: 10/027,155

(22) Filed: Dec. 20, 2001

(51) Int. Cl. H04M 1/00

(52) U.S. Cl. 455/550; 455/557

(57) ABSTRACT

The present invention is a portable communication device with an interchangeable user input module including two input devices, each disposed on one side of the module, opposite each other, to accommodate multiple functions, space limitations, and size reduction. Two or more features are often combined into one portable communication device to increase functionality. Input devices need to be interchangeable in order to facilitate the multiple features, for example, phone, messaging, personal data assistant, and gaming capabilities, of a portable communication device. The reduction in size of portable communication devices leads to space limitations for input devices. Each side of the interchangeable user input module includes a different input device, for example, QWERTY keyboard, numeric telephone input, touch sensitive panel, scratch pad, or gaming keypad. A user would flip the interchangeable user input module depending on which feature or function was needed.

### FIELD OF THE INVENTIONS

The present invention relates to portable communication devices and in particular, the present invention relates to radiotelephone devices integrated with functions requiring multiple input devices.

### BACKGROUND OF THE INVENTIONS

Portable communication devices are becoming more and more popular as size, weight and functionality improve. Portable communication devices traditionally include such devices as portable cellular phones, two-way radios, paging mechanisms, messaging devices, and personal data assistants. Two or more devices are often combined into one portable communication device.

As portable communication devices combine functions, there is a need to combine features to operate the functions separately. Input devices such as a scratch pad, touch screen, or input keys, are required to enter data for such functions as messaging, gaming capabilities, and personal data assistant.

Scratch pads can be used, for example, to input data into a device by writing the corresponding character with a marker, pointer, stylus, finger or hard object. Touch screens display images that can also be selected by a marker, pointer, stylus, finger or hard object, which results in the corresponding image input as data.

Input keys are selected by pushing the button corresponding to the input desired. For example, a QWERTY keyboard includes letters A-Z, as well as numerals 0-9. A cellular numeric telephone input includes numerals 0-9 and function keys SND, END, RCL. The key selected inputs the resultant data into the device.

Two or more functions are often combined into one portable communication device to increase functionality. Input devices need to be in interchangeable in order to facilitate the multiple features of a portable communication device, such as phone, messaging, personal data assistant, and gaming capabilities. The reduction in size of portable communication devices leads to space limitations for input devices. Therefore, there is a need for two input devices disposed on each side of an interchangeable user input module to operate multiple functions and features, particularly on a portable communication device.

The various aspects, features and advantages of the present invention will become more fully apparent to those having ordinary skill in the art upon careful consideration of the following Detailed Description of the Invention with the accompanying drawings described below.

### BRIEF DESCRIPTION OF THE DRAWINGS

FIG. 1 is an electrical block diagram of a portable communication device.

FIG. 2 is an exploded view of an interchangeable user input module.

FIG. 3 is a reverse exploded view of the interchangeable user input module in FIG. 2.

FIG. 4 is an interchangeable user input module and a portable communication device.

FIG. 5 is a perspective view of an interchangeable user input module partially engaged in a portable communication device.

FIG. 6 is a perspective view of an interchangeable user input module fully engaged in a portable communication device.

### DETAILED DESCRIPTION OF THE INVENTIONS

The present invention is a portable communication device with an interchangeable user input module including two input devices, each disposed on one side of the module to accommodate multiple functions, space limitations, and size reduction. Two or more features are often combined into one portable communication device to increase functionality. Input devices need to be interchangeable in order to facilitate the multiple features, for example, phone, messaging, personal data assistant, and gaming capabilities, of a portable communication device. The reduction in size of portable communication devices leads to space limitations for input devices.

The interchangeable user input module for use with a portable communication device includes a double-sided circuit board. The module according the present invention is described as an interchangeable user input module or user input module throughout the specification. Each side of the circuit board includes a different input device, for example, QWERTY keyboard, numeric telephone input, touch sensitive panel, scratch pad, or gaming keypad. A user would flip the interchangeable user input module depending on which feature or function was needed.

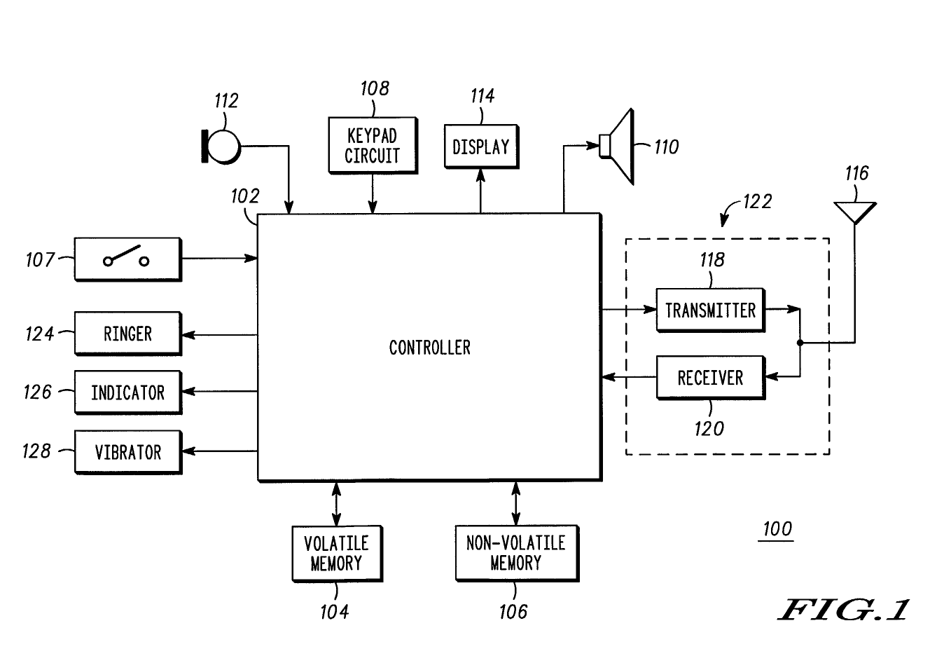

FIG. 1 is an electrical block diagram illustrating circuit 100 positioned within in a portable communication device. Circuit 100 includes controller 102, which may be a microprocessor, a micro-controller, a digital signal processor (DSP), a programmable logic unit, or a combination of such components. Controller 102 can include volatile memory 104, which may for example be random access memory (RAM), and non-volatile memory 106, which may be implemented using Electronically Erasable Programmable Read Only Memory (EEPROM), Flash Read Only Memory (ROM), Electronically Programmable Read Only Memory (EPROM), or the like. Controller 102, or Central Processing Unit (CPU), selectively controls the operation of portable communication device including radiotelephone mode and messaging or PDA mode.

Controller 102 receives information through receptacle 107 in the portable communication device. The contact pad on the interchangeable user input module inserts into receptacle 107. Receptacle 107 registers the contact pad and communicates to controller 102 which input device is engaged into the portable communication device. Controller 102 receives user inputs from keypad 108 of interchangeable user input module. The user input module can be integrated with the phone or interchangeable with other input modules. According to the present invention, two user input devices are on one user input module, one input device on each side of the interchangeable user input module. Controller 102 is also connected to speaker 110 that outputs audio and microphone 112 that inputs audio. Controller 102 drives display 114 that is used to show information to the user.

Antenna 116, a radio frequency (RF) input, is connected between transmitter 118 and receiver 120 of transceiver 122. Transmitter 118 transmits data from controller 102 and receiver 120 receives data and relays the information to controller 102. Ringer 124, indicator 126, and vibrator 128 are alerts for the user and are coupled to controller 102.

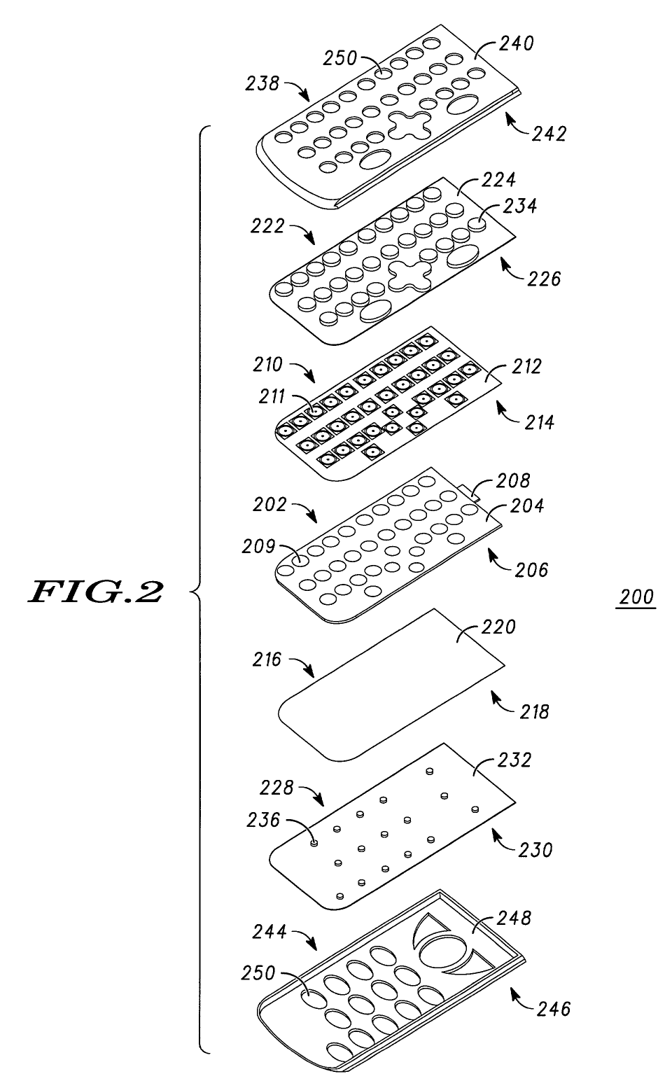

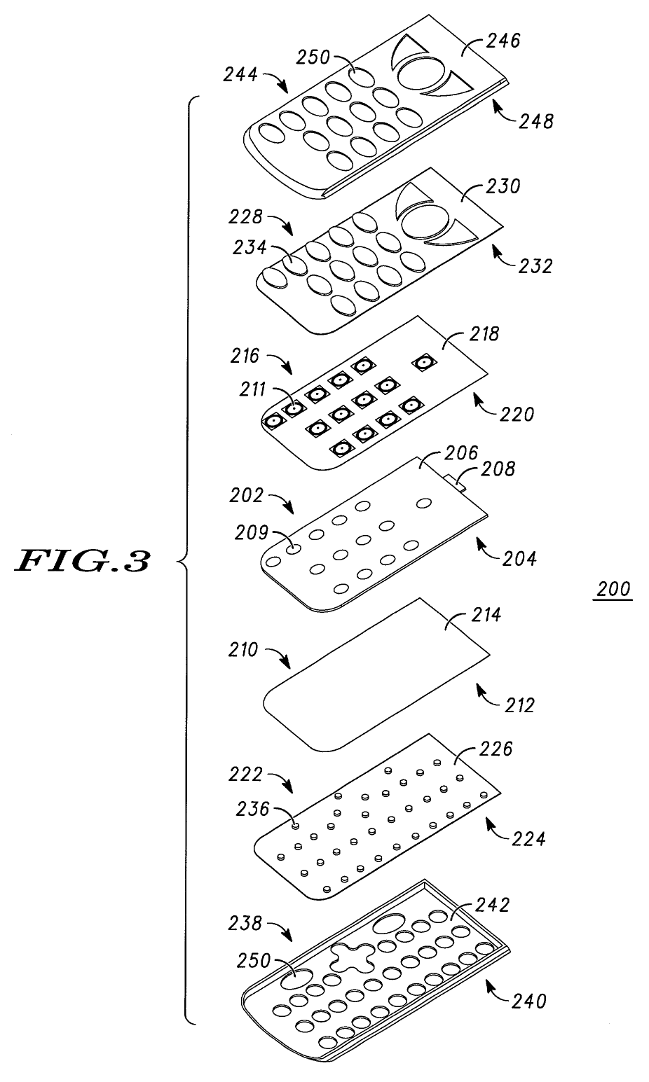

FIG. 2 is an exploded view of an interchangeable user input module. The QWERTY keyboard is displayed on top. FIG. 3 is a reverse exploded view of the interchangeable user input module in FIG. 2. The numeric telephone input is displayed on top. Interchangeable user input module 200 includes two input devices, one on each side of interchangeable user input module 200. The first input device is located opposite of the second input device. The present invention is described with a QWERTY keyboard input device on one side of interchangeable user input module 200 and a numeric telephone input device on the opposite side. A QWERTY keyboard comprises of the alphabetical letters A-Z, numerals 0-9, and various symbol keys such as !, @ and ? for functions including messaging. A numeric telephone input includes numerals 0-9, function keys SND, END, RCL for functions including phone call. The numeric telephone input could be available in various different languages.

Those skilled in the art will recognize that various modifications and variations, in addition to those described, can be made in interchangeable user input module 200 of the present invention and in construction without departing from the scope of the present invention. For example, the input devices of interchangeable user input module 200 can include a touch screen, scratch pad, gaming keypad, or personal data assistant (PDA).

A touch screen and scratch pad detect inputs generated in response to pressure applied to the touch sensitive panel using, for example, a marker, pointer, stylus, or finger. The touch sensitive panel communicates the pressure inputs to the circuitry on the circuit board. Touch screens display images that can also be selected by a marker, pointer, stylus, finger or hard object, which results in the corresponding image input as data. A game keypad includes various keys to operate a game, for example UP, DOWN, JUMP. Since the interchangeable user input module 200 may be used as an aftermarket accessory, the module may be available in various languages.

As shown in FIG. 2 and FIG. 3, circuit board 202 includes a first surface 204 and a second surface 206. The top end of circuit board 202 includes a contact pad 208. Contact pad 208 is an electrical interface and communicates which input device of the interchangeable user input module is engaged in the portable communication device.

Circuit board 202 is double-sided. First surface 204 of circuit board 202 includes circuitry for one input device and the second surface 206 of circuit board 202 includes circuitry for a second input device. First surface 204 includes circuitry for a QWERTY keyboard and second surface 206 includes circuitry for a numeric telephone input. The circuitry includes switches 209 that activate the corresponding function when actuated. It is known to those skilled in the art that the circuitry does not have to be on circuit board 202 of the radio communications handset interchangeable user input module. An alternative embodiment may include the circuitry as part of the radio communication handset including a Subscriber Identity Module (SIM) chip card or Multimedia Card (MMC).

Dome panels include domes 211 adhered to a board. Domes 211 are of metal construction, for example copper, and the board is a Mylar construction. However, it is understood that the domes and board may be constructed from other materials. When domes 211 are actuated, the corresponding switches 209 on the circuit board are activated.

QWERTY dome panel 210 includes domes 211 that activate switches 209 in conjunction with the QWERTY keyboard input device. QWERTY dome panel 210 has a first surface 212 and a second surface 214. Second surface 214 of QWERTY dome panel 210 is aligned with the first surface 204 of circuit board 202.

Numeric telephone input dome panel 216 has a first surface 218 and a second surface 220. Numeric telephone input dome panel 216 includes domes 211 that activate switches 209 in conjunction with the numeric telephone input device. Second surface 220 of numeric telephone input dome panel 216 is aligned with second surface 206 of circuit board 202.

As shown in FIG. 2 and FIG. 3, QWERTY keypad 222 has a first surface 224 and a second surface 226. Second surface 226 of QWERTY keypad 222 is aligned with first surface 212 of QWERTY dome panel 210. Numeric telephone input keypad 228 has a first surface 230 and a second surface 232. Second surface 232 of numeric telephone input keypad 228 is aligned with first surface 218 of numeric telephone input dome panel 216.

First surface 224 of QWERTY keypad 222 and first surface 230 of numeric telephone input keypad 228 have protrusions 234. Posts 236 are located on second surface 226 of QWERTY keypad 222 and on second surface 232 of numeric telephone input keypad 228. Each protrusion 234 has a corresponding post 236. Protrusions 234, domes 211, and switches 209 are aligned so that when protrusions 234 are actuated, the corresponding post 236 actuates domes 211 on the dome panel, which in turn actuates the appropriate switch 209 on circuit board 202. According to the present invention, QWERTY keypad 222 and numeric telephone input keypad 228 are made from silicone rubber. However, it is understood that the keypads may be constructed from other materials.

QWERTY cover 238 has a first surface 240 and a second surface 242. Numeric telephone input cover 244 has a first surface 246 and a second surface 248. QWERTY cover 238 and numeric telephone input cover 244 protect the entire module and include cutouts 250 that align with the corresponding protrusions 234 on QWERTY keypad 222 and numeric telephone input keypad 228. It is understood QWERTY cover 238 and numeric telephone input cover 244 do not have to be part of interchangeable user input module 200. For example, the cover can be a part separate from the portable communication device and the interchangeable user input module.

Second surface 242 of the QWERTY cover 238 is aligned with the first surface 224 of the QWERTY keypad 222. Second surface 248 of numeric telephone input keypad 228 is aligned with first surface 230 of the numeric telephone input keypad 228.

According to the preferred embodiment of the present invention, circuit board 202, QWERTY dome panel 210, numeric telephone input dome panel 216, QWERTY keypad 222, numeric telephone input keypad 228, QWERTY cover 238, and numeric telephone input cover 244 of interchangeable user input module 200 are secured together by snap fit or interference fit. However, it is understood that the interchangeable user input module 200 may be secured together by other methods, for example ultrasonic welding.

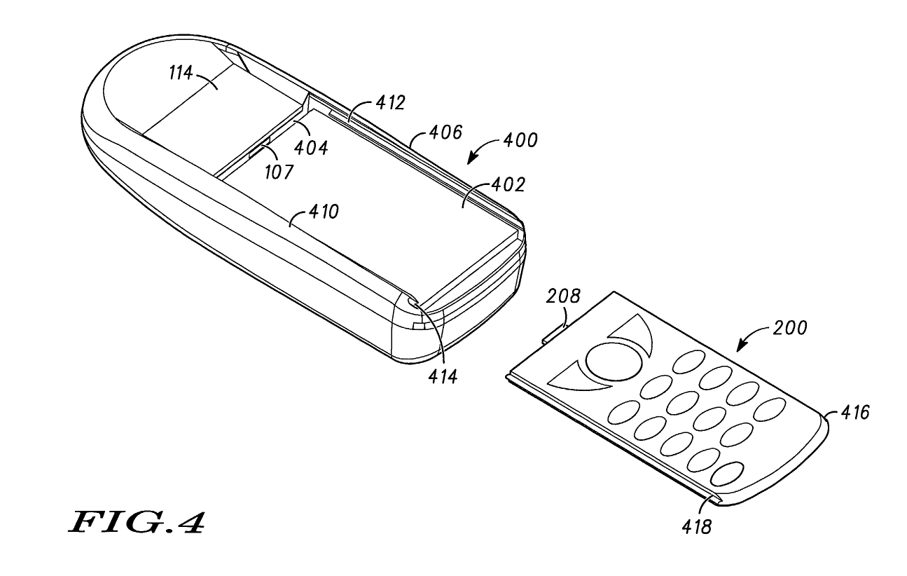

FIG. 4 is an interchangeable user input module 200 and a portable communication device 400 according to the present invention. Portable communication device 400 includes a cavity 402 into which interchangeable user input module 200 is placed. Cavity 402 includes a top side 404, a right side 406, and a left side 410. Cavity 402 is positioned below display 114 of portable communication device 400. Receptacle 107 is on top side 404 of cavity 402. Right groove 412 extends longitudinally along right side 406 of cavity 402 and left groove 414 extends longitudinally along left side 410 of cavity 402. Interchangeable user input module 200 has right rail 416 and left rail 418 for placement into cavity 402.

FIG. 5 is a perspective view of an interchangeable user input module partially engaged in a portable communication device. A user places interchangeable user input module 200 that corresponds to the desired function, such as messaging, personal data assistant, phone, or gaming into cavity 402 of portable communication device 400. Interchangeable user input module 200 is placed into cavity 402 by sliding right rail 416 of interchangeable user input module 200 into right groove 412 on right side 406 of cavity 402 while simultaneously sliding left rail 418 into left groove 414 on left side 410 of cavity 402. As interchangeable user input module 200 is inserted into cavity 402, contact pad 208 aligns and engages into receptacle 107. It is obvious to one of ordinary skill in the art to engage interchangeable user input modules 200 into cavity 402 by various other means, for example snap fit.

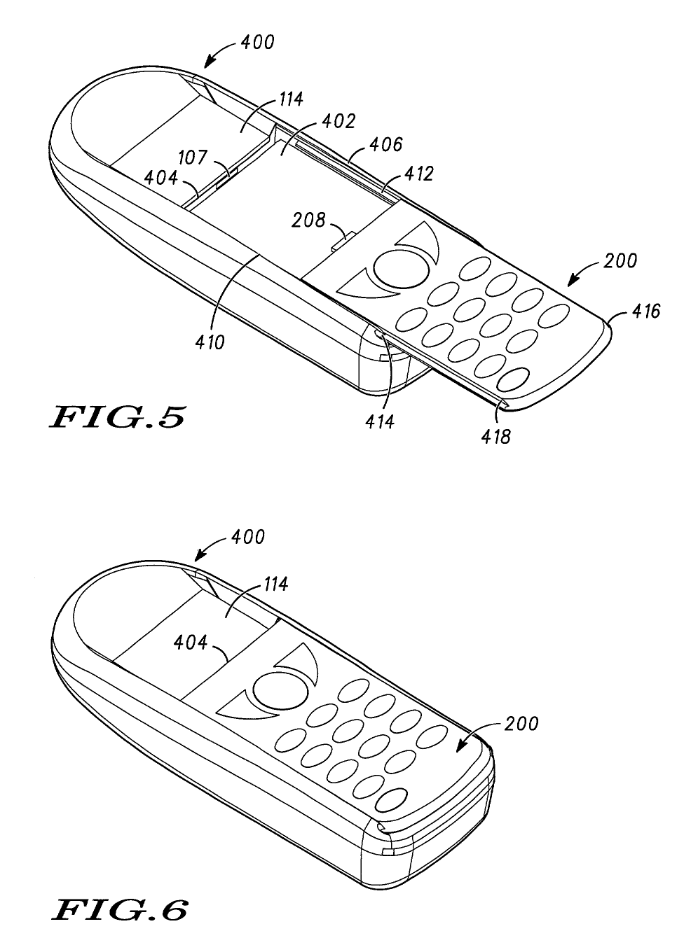

FIG. 6 is a perspective view of an interchangeable user input module fully engaged in a portable communication device. The user selects the desired input device from interchangeable user input module 200, for example QWERTY keyboard, game keypad, or numeric telephone input. Interchangeable user input module 200 is inserted into portable communication device 400. Contact pad 208 is inserted into receptacle 107 located on the top side 404 of cavity 402 in the portable communication device 400. Receptacle 107 is positioned below display 114 on portable communication device 400.

Controller 102 of circuit 100 reads contact pad 208 in order to communicate to the portable communication device 400 which input device of interchangeable user input module 200 is inserted into receptacle 107 and therefore, which mode to enable, for example, personal data assistant, messing, phone, or game.

Once the interchangeable user input module 200 is engaged, input keys are selected by pushing the button corresponding to the input desired, such as a letter or number. The key selected inputs the resultant data into portable communication device 400.

While the present inventions and what is considered presently to be the best modes thereof have been described in a manner that establishes possession thereof by the inventors and that enables those of ordinary skill in the art to make and use the inventions, it will be understood and appreciated that there are many equivalents to the exemplary embodiments disclosed herein and that myriad modifications and variations may be made thereto without departing from the scope and spirit of the inventions, which are to be limited not by the exemplary embodiments but by the appended claims.

We claim:

1. A radio communications handset interchangeable user input module comprising:
a circuit board with a top surface and an opposite bottom surface;
a first input device including a dome panel disposed over and aligned with the top surface of the circuit board,
a keypad disposed over and aligned with the dome panel; and
a second input device disposed on the bottom surface of the circuit board.

2. The radio communications handset interchangeable user input module according to claim 1, the first input device is a QWERTY keyboard.

3. The radio communications handset interchangeable user input module according to claim 1, the first input device is a numeric telephone input device.

4. The radio communications handset interchangeable user input module according to claim 1, the second input device is a touch sensitive panel.

5. The radio communications handset interchangeable user input module according to claim 1, the second input device is a scratch pad.

6. The radio communications handset interchangeable user input module according to claim 1, the second input device is a gaming keypad.

7. A portable communication handset comprising:
a housing having a user input electrical interface;
a user input module interchangeably coupled to the housing in a first and second configuration,
the user input module having a first input device with a corresponding first input device electrical interface, the user input module having a second input device with a corresponding second input device electrical interface,
the first input device electrical interface electrically coupled to the user input electrical interface of the housing when the user input module is coupled to the housing in the first configuration, and
the second input device electrical interface electrically coupled to the user input electrical interface of the housing when the user input module is coupled to the housing in the second configuration.

8. The portable communication handset according to claim 7, the second input device electrical interface not electrically coupled to the user input electrical interface of the housing when the first input device electrical interface is electrically connected to the user input electrical interface of the housing.

9. The portable communication handset according to claim 7, the first input device electrical interface not electrically coupled to the user input electrical interface of the housing when the second input device electrical interface is electrically connected to the user input electrical interface of the housing.

10. The portable communication handset according to claim 7, the first configuration includes the first input device accessibly disposed in the housing.

11. The portable communication handset according to claim 10, the first configuration includes the second input device inaccessibly disposed in the housing.

12. The portable communication handset according to claim 7, the second configuration includes the second input device accessibly disposed in the housing.

13. The portable communication handset according to claim 12, the second configuration includes the first input device inaccessibly disposed in the housing.

14. The portable communication handset according to claim 7, the first configuration is a messaging device.

15. The portable communication handset according to claim 7, the second configuration is a radiotelephone device.

16. A portable communication handset comprising:
a housing;
a user input module interchangeably coupled to the housing in a first and second configurations,
the user input module including a first input device on a first side thereof and a second input device on a second side thereof opposite the first side;
in the first configuration of the user interface module, the first input device is accessibly disposed on the housing and the second input device is inaccessibly disposed at least partially within the housing; and
in the second configuration of the user interface module, the second input device is accessibly disposed on the housing and the first input device is inaccessibly disposed at least partially within the housing.

17. The portable communication handset according to claim 16, the first input device is opposite the second input device.

18. The portable communication handset according to claim 16, the first input device is a QWERTY keyboard and the second input device is a numeric telephone keyboard.
